(19) United States
(12) Patent Application Publication
(10) Pub. No.: US 2026/0005806 A1
(43) Pub. Date: Jan. 1, 2026

(54) Conditional Activation of Radio Resources for Transport Block Repetition

(71) Applicant: Apple Inc., Cupertino, CA (US)

(72) Inventors: Ping-Heng KUO, London (GB); Naveen Kumar R PALLE VENKATA, San Diego, CA (US); Pavan NUGGEHALLI, San Carlos, CA (US); Ralf ROSSBACH, Munich (DE); Yuqin CHEN, Beijing (CN)

(21) Appl. No.: 18/881,010

(22) PCT Filed: Jul. 8, 2022
(86) PCT No.: PCT/CN2022/104690

§ 371 Date: Jan. 3, 2025

(51) Int. Cl. H04L 5/00; H04L 1/1812; H04W 72/044; H04W 72/11; H04W 72/231

(52) U.S. Cl. CPC H04L 5/0044; H04L 1/1812; H04W 72/044; H04W 72/11; H04W 72/231

(57) ABSTRACT

A user equipment (UE) is configured to receive configuration information comprising allocation information for a downlink repetition bundle with a configured number of repetitions and conditional resources associated with the downlink repetition bundle, determine whether the conditional resources associated with the downlink repetition bundle are to be activated and decode a transport block from physical downlink shared channel (PDSCH) received over multiple resources from at least one of the downlink repetition bundle and the conditional resources associated with the downlink repetition bundle.

### TECHNICAL FIELD

This application relates to generally wireless communication, and in particular relates to conditional activation of radio resources for transport block repetition.

### BACKGROUND

A fifth generation (5G) new radio (NR) network may support transport block repetition for uplink and/or downlink communications. Under conventional circumstances, an issue of insufficient repetition may occur where the transmitting device is unable to perform a configured number of transport block repetitions within the network allocated radio resources. For example, in the uplink, a user equipment (UE) may miss some or all of a physical uplink shared channel (PUSCH) opportunity intended for a transport block repetition due to late packet arrival caused by jitter. Similarly, in the downlink, a base station may miss some or all of a physical downlink control channel (PDSCH) opportunity intended for transport block repetition due to late packet arrival caused by jitter. It has been identified that there is a need for mechanisms configured to address insufficient transport block repetition.

### SUMMARY

Some exemplary embodiments are related to a processor of a user equipment (UE) configured to perform operations. The operations include receiving configuration information comprising allocation information for a downlink repetition bundle with a configured number of repetitions and conditional resources associated with the downlink repetition bundle, determining whether the conditional resources associated with the downlink repetition bundle are to be activated and decoding a transport block from physical downlink shared channel (PDSCH) received over multiple resources from at least one of the downlink repetition bundle and the conditional resources associated with the downlink repetition bundle.

Other exemplary embodiments are related to a processor of a base station configured to perform operations. The operations include transmitting configuration information to a user equipment (UE) comprising allocation information for a downlink repetition bundle with a configured number of repetitions and conditional resources associated with the downlink repetition bundle, determining whether the conditional resources associated with the downlink repetition bundle are to be activated and transmitting physical downlink shared channel (PDSCH) to the UE over multiple resources from at least one of the downlink repetition bundle and the conditional resources associated with the downlink repetition bundle, the PDSCH comprising a transport block repetition.

Still further exemplary embodiments are related to a processor of a user equipment (UE) configured to perform operations. The operations include receiving configuration information comprising allocation information for an uplink repetition bundle with a configured number of repetitions and conditional resources associated with the uplink repetition bundle, determining whether the conditional resources associated with the downlink repetition bundle are to be activated and transmitting physical uplink shared channel (PUSCH) to a base station over multiple resources from at least one of the uplink repetition bundle and the conditional resources associated with the uplink repetition bundle, the PUSCH comprising a transport block repetition.

Additional exemplary embodiments include a processor of a base station configured to perform operations. The operations include transmitting configuration information to a user equipment (UE) comprising allocation information for an uplink repetition bundle with a configured number of repetitions and conditional resources associated with the uplink repetition bundle, determining whether the conditional resources associated with the downlink repetition bundle are to be activated and receiving physical uplink shared channel (PUSCH) from the UE over multiple resources from at least one of the uplink repetition bundle and the conditional resources associated with the uplink repetition bundle, the PUSCH comprising a transport block repetition.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4a shows an exemplary repetition bundle according to various exemplary embodiments.

FIG. 4b shows an example scenario during which insufficient repetition occurs according to various exemplary embodiments.

FIG. 5 shows the exemplary repetition bundle and associated conditional resources according to various exemplary embodiments.

FIG. 6 shows multiple examples of one or more activated conditional resources according to various exemplary embodiments.

FIG. 7 shows a method for downlink conditional resource activation for transport block repetition according to various exemplary embodiments.

FIG. 8 shows a method for downlink conditional resource activation for transport block repetition according to various exemplary embodiments.

FIG. 9 shows a method for uplink conditional resource activation for transport block repetition according to various exemplary embodiments.

FIG. 10 shows a method for uplink conditional resource activation for transport block repetition according to various exemplary embodiments.

FIG. 11a shows an example of a single semi-persistent scheduling (SPS) occasion comprising a repetition bundle and a conditional bundle according to various exemplary embodiments.

FIG. 11b shows an example of a single configured grant (CG) occasion comprising a repetition bundle and a conditional bundle according to various exemplary embodiments.

FIG. 12 shows an example abstract syntax notation one (ASN.1) for an SPS-Config information element (IE) that includes the condPdschAggregationFactor IE introduced herein.

FIG. 13 shows an example ASN.1 of an ConfiguredGrantConfig IE that includes the condRep IE introduced herein.

FIG. 14 shows an example of an exemplary medium access control (MAC) control element (CE) for conditional activation of resources for transport block repetition according to various exemplary embodiments.

### DETAILED DESCRIPTION

The exemplary embodiments may be further understood with reference to the following description and the related appended drawings, wherein like elements are provided with the same reference numerals. The exemplary embodiments relate to the conditional activation of radio resources for transport block repetition. As will be described in more detail below, insufficient repetition may occur where a configured number of transport block repetitions cannot be performed within the corresponding network allocated radio resources. The exemplary embodiments introduce the conditional activation of radio resources to ensure that the configured number of transport block repetitions are performed.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to fifth generation (5G) new radio (NR) network that supports extended Reality (XR). Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). However, any reference to XR being specific to a particular use case or type of traffic is merely provided for illustrative purposes. The exemplary embodiments apply to any currently implemented transport block repetition mechanisms, future implementations of transport block repetition mechanisms or independently from other transport block repetition mechanism.

During operation, XR services may utilize multiple data flows in the uplink and/or downlink. For example, in the downlink, there may be a video stream, an audio stream and/or a data stream. In the uplink, there may be a control stream and/or a pose stream. From a physical channel perspective, there may be different control channels and shared channels for each stream or multiple streams may share a control channel and/or shared channel. In some configurations, each stream may have different quality of service (QoS) requirements (e.g., block error rate (BLER), latency requirements, etc.).

For XR services, the data payload is typically periodical. For example, a video frame rate may be 60, 90 or 120 frames per second. The network may obtain assistance information related to the characteristics of the XR traffic and utilize the assistance information to perform resource allocation for the XR services. Due to the periodical nature of XR traffic, a semi-persistent scheduling (SPS) and/or a configured grant (CG) approach may be used by the network for resource allocation.

To increase reliability (e.g., packet success rate, etc.), transport block repetition may be utilized in the uplink and/or downlink. For example, the transport block may be repeated (K) times autonomously during a SPS or CG occasion. Generally, more repetitions are needed for a higher reliability.

For any of a variety of different reasons, including but not limited to late packet arrival caused by jitter, an issue of insufficient repetition may occur where the configured number of transport block repetitions (K) cannot be reached by the transmitting device (e.g., UE, gNB, etc.). For example, in the downlink, late packet arrival at the physical layer (PHY) of the gNB due to jitter may cause the gNB to miss some or all of a physical downlink shared channel (PDSCH) opportunity configured for (K) transport block repetitions. As a result, under conventional circumstances, the configured number of repetitions (e.g., K) is not achieved which may degrade the reliability of the traffic. Similarly, in the uplink, late packet arrival at the PHY layer of the UE due to jitter may cause the UE to muss some or all of a physical uplink shared channel (PUSCH) opportunity configured for (K) transport block repetitions. As a result, under conventional circumstances, the configured number of repetitions (e.g., K) is not achieved which may degrade the reliability of the traffic.

The exemplary embodiments are described with regard to a repetition bundle. Throughout this description, a repetition bundle represents a set of time and frequency radio resources (e.g., resource blocks, resource elements, subcarriers, subframes, etc.) configured to carry the configured number of transport block repetitions (K). In the uplink, the repetition bundle may be mapped to a PUSCH opportunity. In addition, the PUSCH opportunity may be further characterized as a CG opportunity depending on the manner in which the resources were allocated by the network. Thus, in some examples, the terms repetition bundle, PUSCH opportunity and/or CG opportunity may be used interchangeably to refer to the same radio resources. In the downlink, the repetition bundle may be mapped to a PDSCH opportunity. In addition, the PDSCH opportunity may be further characterized as a SPS opportunity depending on the manner in which the resources were allocated by the network. Thus, in some examples, the terms repetition bundle, PDSCH opportunity and/or SPS opportunity may be used interchangeably to refer to the same radio resources.

To differentiate between the different resources of a repetition bundle, the exemplary embodiments characterize the repetition bundle to include (K) sets of radio resources. For example, if the configured number of transport block repetitions is set to a value of four, the resources of the repetitions bundle may be indexed as resources 0-3. However, reference to the term repetition bundle is merely provided for illustrative purposes, different entities may refer to a similar concept by a different name.

The exemplary embodiments introduce conditional activation of radio resources for transport block repetition. This may include performing transport block repetition over a repetition bundle and an associated conditional resource. The exemplary embodiments described herein may allow the network to avoid a scenario in which the configured transport block repetition number (e.g., K) cannot be reached by the transmitting device (e.g., UE, gNB, etc.). According to some aspects, the exemplary embodiments introduce techniques for activating a conditional resource associated with a repetition bundle. In another aspect, the exemplary embodiments introduce techniques for determining which conditional resources are to be activated. In addition, the exemplary embodiments introduce various messages and signaling mechanisms to implement the conditional activation of radio resources for transport block repetitions introduced herein. The exemplary embodiments may be used independently from one another, in conjunction with currently implemented transport block repetition mechanisms, future implementations of transport block repetition mechanisms or independently from other transport block mechanisms.

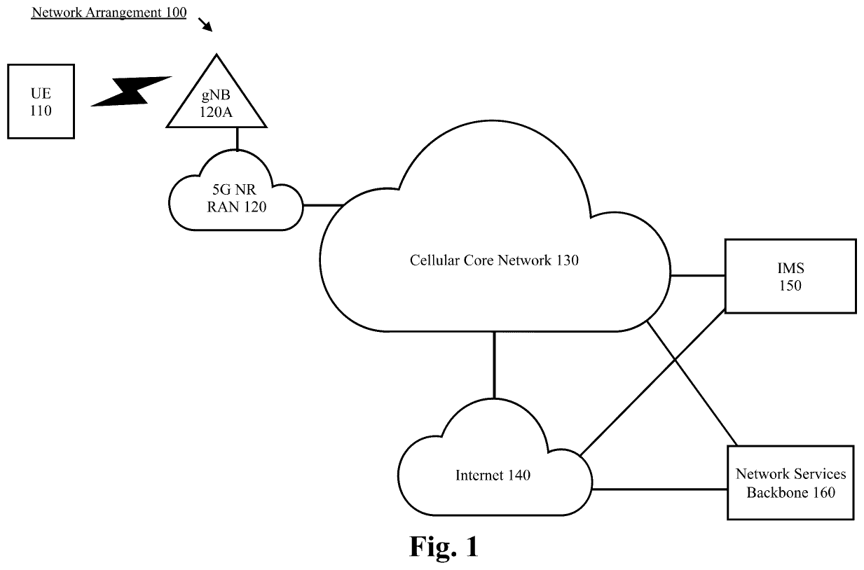

FIG. 1 shows an exemplary network arrangement 100

according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

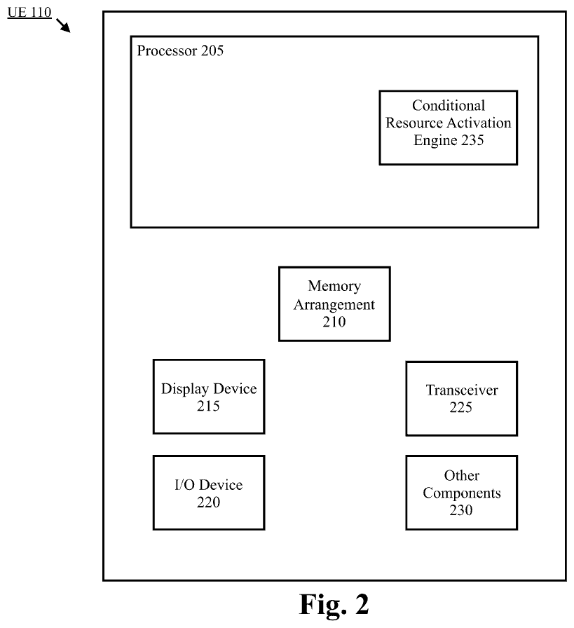

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a conditional resource activation engine 235. The conditional resource activation engine 235 may perform a variety of operations related to utilizing conditional radio resources to ensure sufficient transport block repetition. The operations may include, but are not limited to, receiving configuration information from the network, identifying an empty resource within a repetition bundle, activating a conditional resource associated with a repetition bundle, aggregating data received from a repetition bundle and/or a conditional resource (e.g., downlink communication) and performing transport block repetition over a repetition bundle and/or a conditional resource (e.g., uplink communication).

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

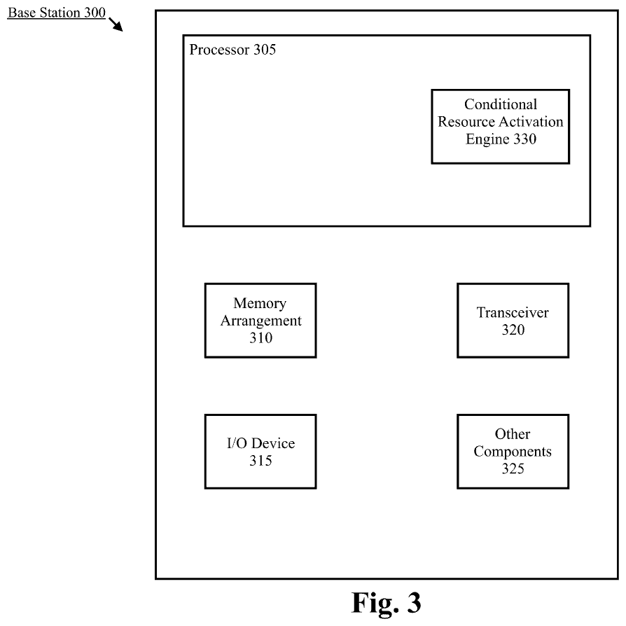

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a conditional resource activation engine 330. The conditional resource activation engine 330 may perform a variety of operations related to utilizing conditional radio resources to ensure sufficient transport block repetition. The operations may include, but are not limited to, transmitting configuration information to one or more UEs, identifying an empty resource within a repetition bundle, activating a conditional resource associated with the repetition, aggregating data received from a repetition bundle and/or a conditional resource (e.g., uplink communication) and performing transport block repetition over a repetition bundle and/or a conditional resource (e.g., downlink communication).

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In 5G NR, a transport block may refer to data that is passed between the medium access control (MAC) and physical PHY layers. The transport block may then be processed at the PHY layer and mapped onto radio resources for transmission over the air. In downlink examples, the transport block may be mapped to PDSCH resources. In uplink examples, the transport block may be mapped to PUSCH resources.

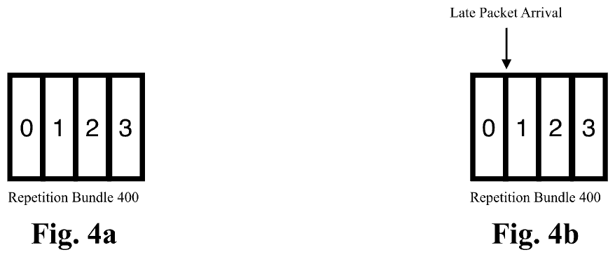

FIG. 4a shows an exemplary repetition bundle 400 according to various exemplary embodiments. The repetition bundle 400 represents a set of time and frequency radio resources (e.g., resource blocks, resource elements, subcarriers, subframes, etc.) configured to carry the configured number of transport block repetitions (K). In this example, the transport block repetition is set to K=4. Each instance of the transport block is intended to be transmitted over a portion of the resources of the repetition bundle. In this example, the repetition bundle includes four sets of resources indexed 0-3. Resource 0 may include a first instance of the transport block, resource 1 may include a second instance of the transport block, resource 2 may include a third instance of the transport block and resource 3 may include a fourth instance of the transport block. The resources of the repetition bundle (e.g., resources 0-3) may be configured with the same HARQ ID which enables the receiving entity (e.g., UE 110, gNB 120A, etc.) to aggregate them properly.

FIG. 4b shows an example scenario during which insufficient repetition occurs according to various exemplary embodiments. The example scenario is described with regard to the repetition bundle 400 being transmitted by the gNB 120A in the downlink to the UE 110. Here, late packet arrival at the gNB 120A caused by jitter occurs after the corresponding PDSCH opportunity has started and the gNB 120A misses a first portion of the corresponding PDSCH opportunity (e.g., resource 0). As a result, insufficient repetition may occur and only three transport blocks (e.g., resources 1-3) may be transmitted by the gNB 120A during the corresponding PDSCH opportunity.

According to some aspects, each repetition bundle may be associated with a set of conditional resources. Like the repetition bundle, the conditional resources may represent a set of time and frequency radio resources (e.g., resource blocks, resource elements, subcarriers, subframes, etc.) configured to carry the configured number of transport block repetitions (K). The network may preconfigure the conditional resources based on characteristics information (e.g., expected jitter, etc.) relating to the traffic flow intended to be transmitted on the repetition bundle. The conditional resources may be allocated on the same serving cell as the repetition bundle or on a different serving cell as the repetition bundle. The repetition bundle and the associated conditional resources may be configured with the same HARQ process ID to enable the receiving entity (e.g., UE 110, gNB 120A) to aggregate data transmitted over the repetition bundle and the conditional resources.

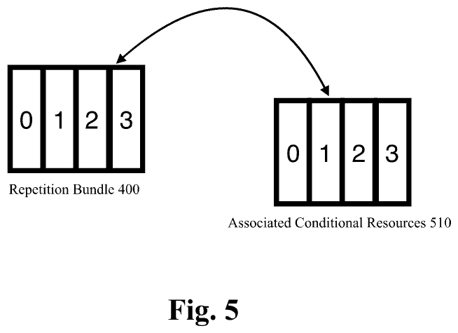

FIG. 5 shows the exemplary repetition bundle 400 and associated conditional resources 510 according to various exemplary embodiments. Throughout this description, to differentiate between the different resources within the set of the conditional resources, the exemplary embodiments characterize the set of conditional resources to include (K) sets of radio resources. For example, if the configured number of transport block repetitions is set to a value of four, the set of conditional resources may be indexed as conditional resources 0-3. The number of conditional resources within the set of conditional resources that are actually utilized may vary and depend on the number of transport block repetitions actually performed during the associated repetition bundle. However, reference to the term conditional resources is merely provided for illustrative purposes, different entities may refer to a similar concept by a different name.

In this example, the set of conditional resources 510 may include conditional resources indexed 0-3. Conditional resource 0 may include a first instance of the transport block, conditional resource 1 may include a second instance of the transport block, conditional resource 2 may include a third instance of the transport block and conditional resource 3 may include a fourth instance of the transport block. In some embodiments, all of the conditional resources may be utilized for transport block repetition. In other embodiments, only a subset of the conditional resources may be utilized for transport block repetition. In further embodiments, a set of conditional resources may be associated with more than one repetition bundle.

The conditional resources may be configured in an activated or deactivated state. When in the deactivated state, the UE 110 and the network may be aware of the configuration of the set of conditional resources associated with a repetition bundle but may not actually utilize any of the conditional resources for transport block repetition. When one or more conditional resources are in an activated state, transport block repetition may be performed over the one or more conditional resources and one or more resources of the repetition bundle.

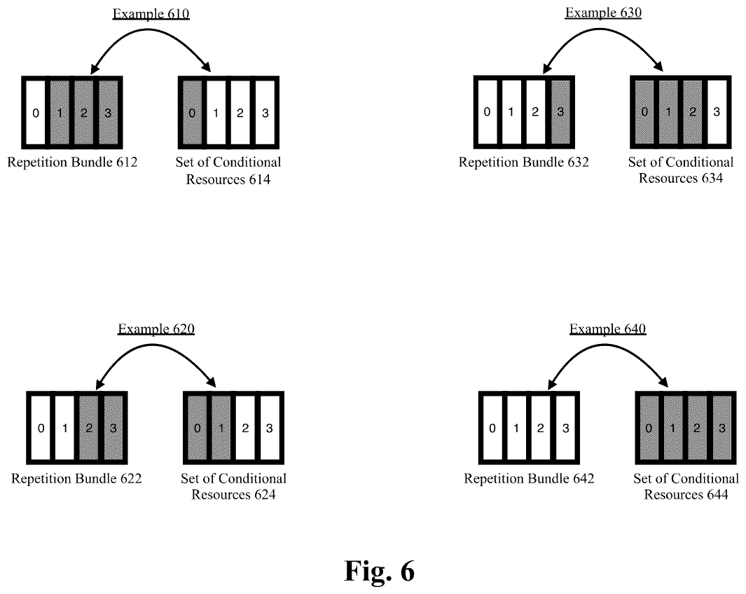

According to some aspects, when one or more resources of the repetition bundle are perceived to be empty, at least a portion of the conditional resources may be activated. The subset of conditional resources to be activated may be dependent on which resource of the repetition bundle are perceived to be empty. In some embodiments, in either the uplink or the downlink, the UE 110 and the gNB 120A independently determine whether one or more conditional resources are to be utilized for transport block repetition. Alternatively, in other embodiments, explicit signaling may be embedded in the repetition bundle to indicate whether at least a subset of the conditional resources should be activated. The explicit signaling may also indicate the allocation of the conditional resource to be activated which in some embodiments, may override preconfigured associated conditional resource. Additional details for both of these types of exemplary embodiments are provided below after the description of FIG. 6.

FIG. 6 shows multiple examples of one or more activated conditional resources according to various exemplary embodiments. In example 610, resource 0 of repetition bundle 612 is empty. In a downlink scenario, the gNB 120A may miss a portion of the corresponding PDSCH opportunity due to late packet arrival. Thus, only three transport block repetitions may be performed by the gNB 120A over the repetition bundle 612. The UE 110 may monitor for but not receive PDSCH over resource 0 of the repetition bundle 612. However, the UE 110 receives PDSCH over resources 1-3 of the repetition bundle 612. Since resource 0 of repetition bundle 612 is empty, resource of the set of conditional resources 614 may be activated. Thus, in this example, the UE 110 also receives PDSCH on resource 0 of the set of conditional resources 614. In an uplink scenario, the UE 110 may miss a portion of the corresponding PUSCH opportunity due to late packet arrival. Thus, only three transport block repetitions may be performed by the UE 110 over the repetition bundle 612. The gNB 120A may monitor for but not receive PUSCH over resource 0 of the repetition bundle 612. However, the gNB 120A receives PUSCH over resources 1-3 of the repetition bundle 612. Since resource 0 of repetition bundle 612 is empty, resource 0 of the set of conditional resources 614 may be activated. Thus, in this example, the gNB 120A also receives PUSCH on resource 0 of the set of conditional resources 614.

In example 620, resources 0-1 of repetition bundle 622 are empty. In a downlink scenario, the gNB 120A may miss a portion of the corresponding PDSCH opportunity due to late packet arrival. Thus, only two transport block repetitions may be performed by the gNB 120A over the repetition bundle 622. The UE 110 may monitor for but not receive PDSCH over resources 0-1 of the repetition bundle 622. However, the UE 110 receives PDSCH over resources 2-3 of the repetition bundle 622. Since resources 0-1 of repetition bundle 622 are empty, resources 0-1 of the set of conditional resources 624 may be activated. Thus, in this example, the UE 110 also receives PDSCH on resources 0-1 of the set of conditional resources 624. In an uplink scenario, the UE 110 may miss a portion of the corresponding PUSCH opportunity due to late packet arrival. Thus, only two transport block repetitions may be performed by the UE 110 over the repetition bundle 622. The gNB 120A may monitor for but not receive PUSCH over resources 0-1 of the repetition bundle 622. However, the gNB 120A receives PUSCH over resources 2-3 of the repetition bundle 622. Since resources 0-1 of repetition bundle 622 are empty, resources 0-1 of the set of conditional resources 624 may be activated. Thus, in this example, the gNB 120A also receives PUSCH on resources 0-1 of the set of conditional resources 624.

In example 630, resources 0-2 of repetition bundle 632 are empty. In a downlink scenario, the gNB 120A may miss a portion of the corresponding PDSCH opportunity due to late packet arrival. Thus, only one transport block repetition may be performed by the gNB 120A over the repetition bundle 632. The UE 110 may monitor for but not receive PDSCH over resources 0-2 of the repetition bundle 632. However, the UE 110 receives PDSCH over resource 3 of the repetition bundle 632. Since resources 0-2 of repetition bundle 632 are empty, resources 0-2 of the set of conditional resources 634 may be activated. Thus, in this example, the UE 110 also receives PDSCH on resources 0-2 of the set of conditional resources 634. In an uplink scenario, the UE 110 may miss a portion of the corresponding PUSCH opportunity due to late packet arrival. Thus, only one transport block repetition may be performed by the UE 110 over the repetition bundle 632. The gNB 120A may monitor for but not receive PUSCH over resources 0-2 of the repetition bundle 632. However, the gNB 120A receives PUSCH over resource 3 of the repetition bundle 632. Since resources 0-2 of repetition bundle 632 are empty, resources 0-2 of the set of conditional resources 634 may be activated. Thus, in this example, the gNB 120A also receives PUSCH on resources 0-2 of the set of conditional resources 634.

In example 640, resources 0-3 of repetition bundle 632 are empty. In a downlink scenario, the gNB 120A may miss all of the corresponding PDSCH opportunity due to late packet arrival. Thus, transport block repetition may not be performed by the gNB 120A over the repetition bundle 642. The UE 110 may monitor for but not receive PDSCH over resources 0-3 of the repetition bundle 642. Since resources 0-3 of repetition bundle 642 are empty, resources 0-3 of the set of conditional resources 644 may be activated. Thus, in this example, the UE 110 receives PDSCH on resources 0-3 of the set of conditional resources 644. In an uplink scenario, the UE 110 may miss all of the corresponding PUSCH opportunity due to late packet arrival. Thus, transport block repetition may not be performed by the UE 110 over the repetition bundle 642. The gNB 120A may monitor for but not receive PUSCH over resources 0-3 of the repetition bundle 642. Since resources 0-3 of repetition bundle 642 are empty, resources 0-3 of the set of conditional resources 644 may be activated. Thus, in this example, the gNB 120A receives PUSCH on resources 0-3 of the set of conditional resources 644.

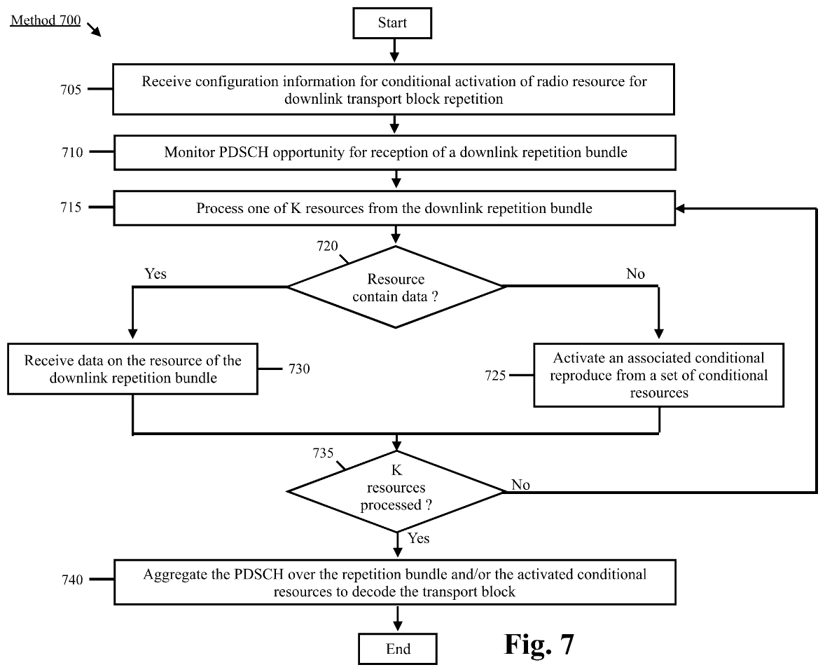

FIG. 7 shows a method 700 for downlink conditional resource activation for transport block repetition according to various exemplary embodiments. The method 700 is described from the perspective of the UE 110 of FIG. 2. The method 800 provided below after the description of the method 700 will provide an example of downlink conditional resource activation for transport block repetition from the perspective of a base station (e.g., gNB 120A).

Initially, consider a scenario in which the UE 110 is connected to the gNB 120A of the 5G NR RAN 120. The gNB 120A is configured to perform transport block repetition in the downlink where the transport block repetition number is (K) and the repetition bundle is arranged into (K) sets of consecutive radio resources.

In 705, the UE 110 receives one or more messages comprising configuration information for conditional activation of radio resources for downlink transport block repetition from the gNB 120A. The configuration information may include, but is not limited to, an allocation information of radio resources for at least one downlink repetition bundle with (K) repetitions and allocation information of conditional resources associated with the at least one downlink reception bundle.

In one example, PDSCH opportunities may be configured at the UE 110 for the reception of downlink repetition bundles using SPS (e.g., SPS opportunities). The configuration information may directly or indirectly identify time, frequency and/or space locations for a set of conditional resources associated with the downlink repetition bundles. In some embodiments, a single continuous PDSCH opportunity may comprise both the repetition bundle and the set of conditional resources. In other embodiments, there may be a fixed or dynamic offset between the repetition bundle and associated set of conditional resources. The repetition bundle and its associated set of conditional resources may be provided on a same serving cell or on different serving cells.

In 710, the UE 110 monitors a PDSCH opportunity for the reception of a downlink repetition bundle from the gNB 120A. For example, the UE 110 may tune its transceiver 225 to the gNB 120A during the scheduled PDSCH opportunity.

In 715, the UE 110 processes one of K resources from the downlink repetition bundle. In other words, the UE 110 listens to a portion of the PDSCH opportunity to determine whether the frequency resources of the PDSCH opportunity contain data (e.g., one of (K) transport blocks).

In 720, the UE 110 determines whether one of the resources of the repetition bundle contains data. If the resource does not contain data, the method 700 continues to 725. In 725, the UE 110 activates an associated conditional resource from the set of conditional resources. When in the activated state, the UE 110 is configured to monitor for at least one conditional resource. As will be described in more detail below, the at least one activated conditional resource and zero or more resources from the repetition bundle may be aggregated to decode the transport block.

In some embodiments, the UE 110 may send a confirmation signal to the gNB 120A indicating that at least one conditional resource has been activated by the UE 110. In other embodiments, the gNB 120A and the UE 110 may not exchange any messages explicitly identifying that conditional resources have been activated at the UE 110. Instead, by performing the methods 700 on the UE 110 side and the method 800 on the gNB 120A side, both the UE 110 and the gNB 120A may independently determine which repetition bundle and/or conditional resources are to be used for transport block repetition.

Returning to 720, if the resource contains data, the method 700 continues to 730. In 730, the UE 110 receives data on the resource of the repetition bundle.

In 735, the UE 110 determines whether K resources of the repetition bundle have been processed. If less than K resources of the repetition bundle have been processed by the UE 110 (e.g., the PDSCH opportunity is not over), the method 700 returns to 715. If K resources of the repetition bundle have been processed by the UE 110, the method 700 continues to 740.

In 740, the UE 110 aggregates the PDSCH over the repetition bundle and/or the activated conditional resources to decode the transport block. For example, if each of the K resources of the repetition bundle contain data, the UE 110 may not activate any of the conditional resources. If at least one of the K resources of the repetition bundle do not contain data, the UE 110 may activate the corresponding at least one conditional resources of the set of associated conditional resources. If none of the K resources of the repetition bundle contain data, the UE 110 may activate the set of associated conditional resources.

The reception of the PDSCH of the associated conditional resources may be performed after the PDSCH opportunity for the repetition bundle has ended. In other embodiments, the set of conditional resources may overlap partially in time with the repetition bundle. However, these examples are merely provided for illustrative purposes. The exemplary embodiments may utilize conditional resources provided on any appropriate time, frequency and/or space resources.

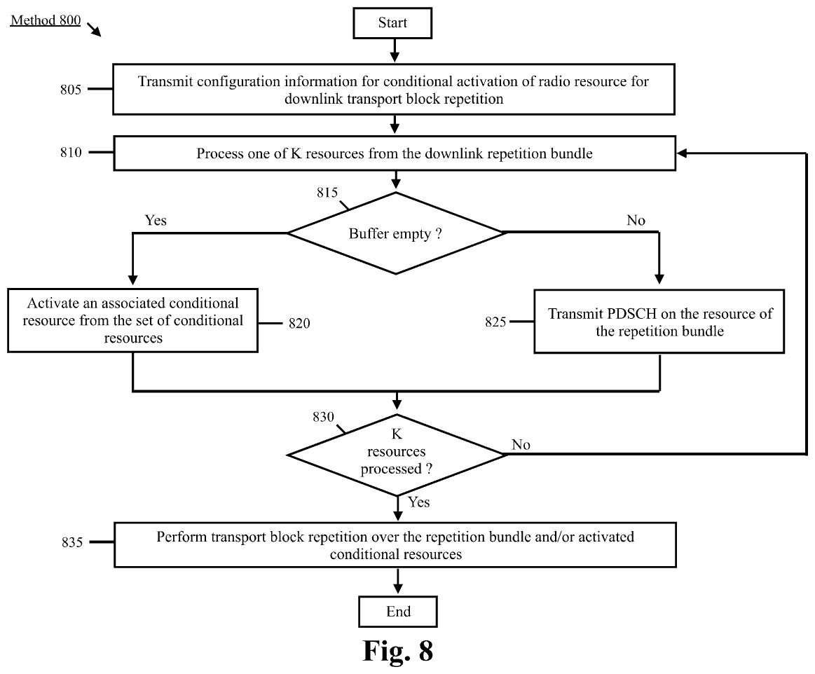

FIG. 8 shows a method 800 for downlink conditional resource activation for transport block repetition according to various exemplary embodiments. The method 800 is described from the perspective of the gNB 120A.

In 805, the gNB 120 transmits one or more messages comprising configuration information for conditional activation of radio resources for downlink transport block repetition to the UE 110. The configuration information may include, but is not limited to, allocation information of radio resources for at least one downlink repetition bundle with (K) repetitions and allocation information of conditional resources associated with the at least one downlink reception bundle. The configuration in 805 is the same configuration information described above in 705 of the method 700.

In 810, the gNB 120A processes one of K resources for the downlink repetition bundle. For example, as mentioned above, the gNB 120A may receive data from other network components (e.g., core network, edge server, etc.) that is to be delivered to the UE 110. The data is provided from the MAC layer of the qNB 120A to the PHY layer of the gNB 120A where it can be mapped to the PDSCH opportunity for transmission over the air.

In 815, the gNB 120A determines whether a buffer corresponding to this downlink repetition bundle is empty (e.g., late packet arrival, no HARQ retransmissions, etc.). In one embodiment, the buffer may be a logical channel (LCH) buffer which is used to buffer data that is still in the radio link control (RLC) layer, e.g., not yet processed by the MAC. When the MAC has a transmission opportunity, the gNB 120A may check if there is any data in the LCH buffer and determine how a transport block should be constructed for this transmission opportunity. However, reference to a LCH buffer is merely provided for illustrative purposes. Different entities may refer to a similar concept by a different name. For example, the terms LCH buffer and RLC buffer may be used interchangeably to refer to the same type of buffer. In another embodiment, the buffer may be a HARQ buffer which is used to buffer a transport block that is already constructed. For example, if a HARQ retransmission is triggered, the gNB 120A may retrieve a transport block stored in the HARQ buffer and transmit the transport block again. However, reference to a HARQ buffer is merely provided for illustrative purposes. Different entities may refer to a similar concept by a different name. In further embodiments, multiple buffers may be considered. Thus, reference to the term buffer in this example may represent one of more buffers (e.g., LCH buffer, HARQ buffer, any other appropriate buffer, etc.) corresponding to the downlink repetition bundle.

When the buffer is empty, the gNB 120A does not have any data available to transmit to the UE 110 during the resource of the repetition bundle. When the buffer contains data, the data may be mapped to the corresponding PDSCH resources.

If the buffer is empty, the method 800 continues to 820. In 820, the gNB 120A activates an associated conditional resource from the set of conditional resources. When in the activated state, the gNB 120A is configured to transmit data on at least one conditional resource. As will be described in more detail below, the at least one activated conditional resource and zero or more resources from the repetition bundle may be used for transport block repetition.

In some embodiments, the gNB 120A may send a signal to the UE 110 in the repetition bundle (or using any other appropriate resources) indicating that at least one conditional resource has been activated. In other embodiments, the gNB 120A and the UE 110 may not exchange any messages explicitly identifying that conditional resources have been activated. Instead, by performing the methods 700 on the UE 110 side and the method 800 on the gNB 120A side, both the UE 110 and the gNB 120A independently determine which repetition bundle and/or conditional resources are to be used for transport block repetition.

Returning to 815, if the buffer is not empty and contains adequate data, the method 800 continues to 825. In 825, the gNB 120A transmits PDSCH (e.g., data, etc.) on the resource of the repetition bundle.

In 830, the gNB 120A determines whether K resources of the repetition bundle have been processed. If less than K resources of the repetition bundle have been processed by the gNB 120A (e.g., the PDSCH opportunity is not over), the method 800 returns to 810. If K resources of the repetition bundle have been processed by the gNB 120A, the method 800 continues to 835.

In 835, the gNB 120A performs transport block repetition over the repetition bundle and/or activated conditional resources. For example, if each of the K resources of the repetition bundle contain data, the gNB 120A may not activate any of the conditional resources. If at least one of the K resources of the repetition bundle do not contain data, the gNB 120A may activate the corresponding at least one conditional resources of the set of associated conditional resources. If none of the K resources of the repetition bundle contain data, the gNB 120A may activate the set of associated conditional resources.

The transmission of the PDSCH of the associated conditional resources may be performed after the PDSCH opportunity for the repetition bundle has ended. In other embodiments, the set of conditional resources may overlap partially in time with the repetition bundle. However, these examples are merely provided for illustrative purposes. The exemplary embodiments may utilize conditional resources provided on any appropriate time, frequency and/or space resources.

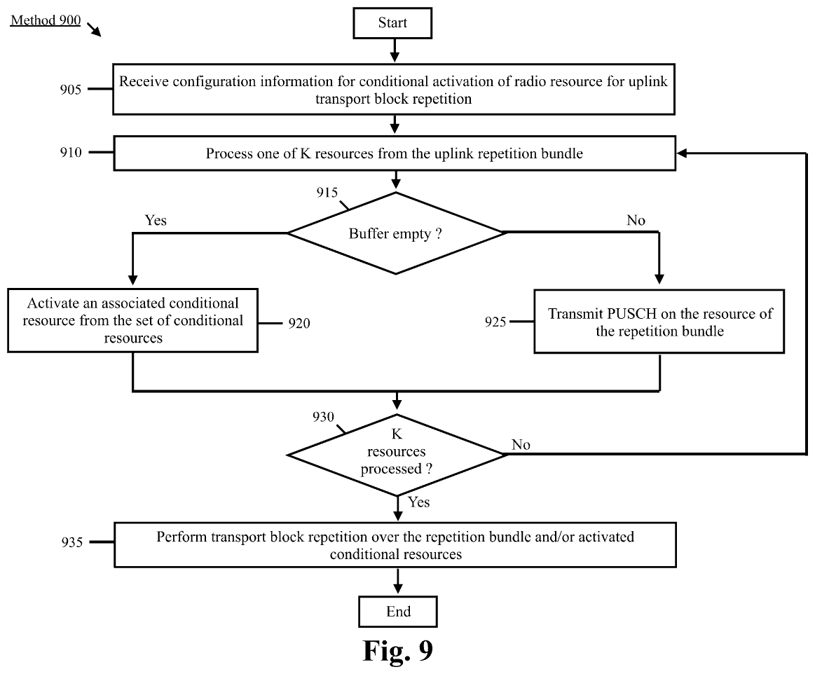

FIG. 9 shows a method 900 for uplink conditional resource activation for transport block repetition according to various exemplary embodiments. The method 900 is described from the perspective of the UE 110 of FIG. 2. The method 1000 provided below after the description of the method 900 will provide an example of uplink conditional resource activation for transport block repetition from the perspective of a base station (e.g., gNB 120A).

Initially, consider a scenario in which the UE 110 is connected to the gNB 120A of the 5G NR RAN 120. The UE 110 is configured to perform transport block repetition in the uplink where the transport block repetition number is (K) and the repetition bundle is arranged into (K) sets of consecutive radio resources.

In 905, the UE 110 receives one or more messages comprising configuration information for conditional activation of radio resources for uplink transport block repetition from the gNB 120A. The configuration information may include, but is not limited to, an allocation information of radio resources for at least one uplink repetition bundle with (K) repetitions and allocation information of conditional resources associated with the at least one uplink reception bundle.

In one example, PUSCH opportunities may be configured at the UE 110 for the transmission of uplink repetition bundles using a CG approach (e.g., CG opportunities). The configuration information may directly or indirectly identify time, frequency and/or space locations for a set of conditional resources associated with the uplink repetition bundles. In some embodiments, a single continuous PUSCH opportunity may comprise both the repetition bundle and the set of conditional resources. In other embodiments, there may be a fixed or dynamic offset between the repetition bundle and associated set of conditional resources. The repetition bundle and its associated set of conditional resources may be provided on a same serving cell or on different serving cells.

In 910, the UE 110 processes one of K resources for the uplink repetition bundle. For example, as mentioned above, the UE 110 may receive data from other UE components and/or associated devices (e.g., application running on the UE 110, HMD, AR glasses, etc.) that are to be delivered to the network. The data is provided from the MAC layer of the UE 110 to the PHY layer of the UE 110 where it can be mapped to the PUSCH opportunity for transmission over the air.

In 915, the UE 110 determines whether a buffer of the corresponding to this uplink repetition bundle is empty (e.g., late packet arrival). In one embodiment, the buffer may be a LCH buffer which is used to buffer data that is still in the RLC layer, e.g., not yet processed by the MAC. When the MAC has a transmission opportunity, the UE 110 may check if there is any data in the LCH buffer and determine how a transport block should be constructed for this transmission opportunity. However, reference to a LCH buffer is merely provided for illustrative purposes. Different entities may refer to a similar concept by a different name. For example, the terms LCH buffer and RLC buffer may be used interchangeably to refer to the same type of buffer. In another embodiment, the buffer may be a HARQ buffer which is used to buffer a transport block that is already constructed. For example, if a HARQ retransmission is triggered, the UE 110 may retrieve a transport block stored in the HARQ buffer and transmit the transport block again. However, reference to a HARQ buffer is merely provided for illustrative purposes. Different entities may refer to a similar concept by a different name. In further embodiments, multiple buffers may be considered. Thus, reference to the term buffer in this example may represent one of more buffers (e.g., LCH buffer, HARQ buffer, any other appropriate buffer, etc.) corresponding to the downlink repetition bundle.

When the buffer is empty, the UE 110 does not have any data available to transmit to the network during the resource of the repetition bundle. When the buffer contains data, the data may be mapped to the corresponding PUSCH resources of the PUSCH opportunity for the repetition bundle.

If the buffer is empty, the method 900 continues to 920. In 920, the UE 110 activates an associated conditional resource from the set of conditional resources. When in the activated state, the UE 110 is configured to transmit data on at least one conditional resource. As will be described in more detail below, the at least one activated conditional resource and zero or more resources from the repetition bundle may be used for transport block repetition.

In some embodiments, the UE 110 may send a signal to the gNB 120A in the repetition bundle (or using any other appropriate resources) indicating that at least one conditional resource has been activated. In other embodiments, the UE 110 and the gNB 120A do not exchange any messages explicitly identifying that conditional resources have been activated. Instead, by performing the methods 900 on the UE 110 side and the method 1000 on the gNB 120A side, both the UE 110 and the gNB 120A may independently determine which repetition bundle and/or conditional resources are to be used for transport block repetition.

Returning to 915, if the buffer contains adequate data, the method 900 continues to 925. In 925, the UE 110 transmits PUSCH (e.g., data, etc.) on the resources of the repetition bundle.

In 930, the UE 110 determines whether K resources of the repetition bundle have been processed. If less than K resources of the repetition bundle have been processed by the UE 110 (e.g., the PUSCH opportunity is not over), the method 900 returns to 910. If K resources of the repetition bundle have been processed by the UE 110, the method 900 continues to 935.

In 935, the UE 110 performs transport block repetition over the repetition bundles and/or activated conditional resources. For example, if each of the K resources of the repetition bundle contain data, the UE 110 may not activate any of the conditional resources. If at least one of the K resources of the repetition bundle do not contain data, the UE 110 may activate the corresponding at least one conditional resource from the set of associated conditional resources. If none of the K resources of the repetition bundle contain data, the UE 110 may activate the set of associated conditional resources.

The transmission of the PUSCH of the associated conditional resources may be performed after the PUSCH opportunity for the repetition bundle has ended. In other embodiments, the set of conditional resources may overlap partially in time with the repetition bundle. However, these examples are merely provided for illustrative purposes. The exemplary embodiments may utilize conditional resources provided on any appropriate time, frequency and/or space resources.

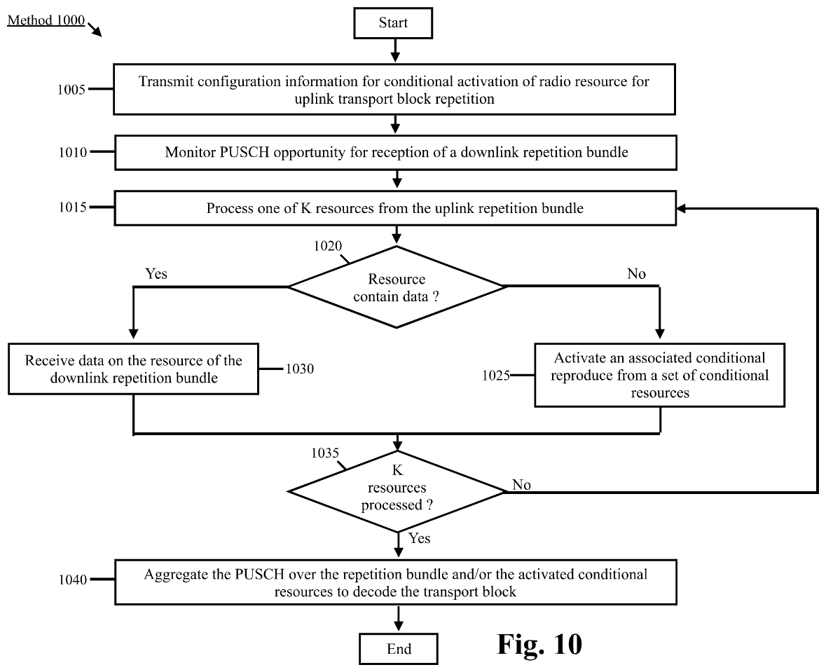

FIG. 10 shows a method 1000 for uplink conditional resource activation for transport block repetition according to various exemplary embodiments. The method 1000 is described from the perspective of the gNB 120A.

In 1005, the gNB 120 transmits one or more messages comprising configuration information for conditional activation of radio resources for uplink transport block repetition to the UE 110. The configuration information may include, but is not limited to, allocation information of radio resources for at least one downlink repetition bundle with (K) repetitions and allocation information of conditional resources associated with the at least one downlink reception bundle. The configuration in 1005 is the same configuration information described above in 905 of the method 900.

In 1010, the gNB 120A monitors a PUSCH opportunity for the reception of an uplink repetition bundle from the gNB 120A. In 1015, the gNB 120A processes one of K resources from the uplink repetition bundle. In other words, the gNB 120A listens to a portion of the PUSCH opportunity to determine whether the frequency resources of the PDSCH opportunity contain data (e.g., one of (K) transport blocks).

In 1020, the gNB 120A determines whether one of the resources of the repetition bundle contains data. If the resource does not contain data, the method 1000 continues to 1025. In 1025, the gNB 120A activates an associated conditional resource from the set of conditional resources. When in the activated state, the gNB 120A is configured to monitor for at least one conditional resource. As will be described in more detail below, the at least one activated conditional resource and zero or more resources from the repetition bundle may be aggregated to decode the transport block.

In some embodiments, the gNB 120A may send a confirmation signal to the UE 110 indicating that at least one conditional resource has been activated by the gNB 120A. In other embodiments, the gNB 120A and the UE 110 do not exchange any messages explicitly identifying that conditional resources have been activated. Instead, by performing the methods 900 on the UE 110 side and the method 1000 on the gNB 120A side, both the UE 110 and the gNB 120A may independently determine which repetition bundle and/or conditional resources are to be used for transport block repetition.

Returning to 1020, if the resource contains data, the method 1000 continues to 1030. In 1030, the gNB 120A receives data on the resource of the repetition bundle.

In 1035, the gNB 120A determines whether K resources of the repetition bundle have been processed. If less than K resources of the repetition bundle have been processed by the qNB 120A (e.g., the PUSCH opportunity is not over), the method 1000 returns to 1015. If K resources of the repetition bundle have been processed by the gNB 120A, the method 1000 continues to 1040.

In 1040, the gNB 120A aggregates the PUSCH over the repetition bundle and/or the activated conditional resources to decode the transport block. For example, if each of the K resources of the repetition bundle contain data, the gNB 120A may not activate any of the conditional resources. If at least one of the K resources of the repetition bundle do not contain data, the gNB 120A may activate the corresponding at least one conditional resources of the set of associated conditional resources. If none of the K resources of the repetition bundle contain data, the gNB 120A may activate the set of associated conditional resources.

The reception of the PUSCH of the associated conditional resources may be performed after the PUSCH opportunity for the repetition bundle has ended. In other embodiments, the set of conditional resources may overlap partially in time with the repetition bundle. However, these examples are merely provided for illustrative purposes. The exemplary embodiments may utilize conditional resources provided on any appropriate time, frequency and/or space resources.

According to some aspects, a PDSCH occasion or PUSCH occasion may comprise a repetition bundle and a conditional bundle (e.g., a set of conditional resources). For example, a single SPS occasion may include a repetition bundle and conditional bundle. In another example, a single CG occasion may include a repetition bundle and a conditional bundle.

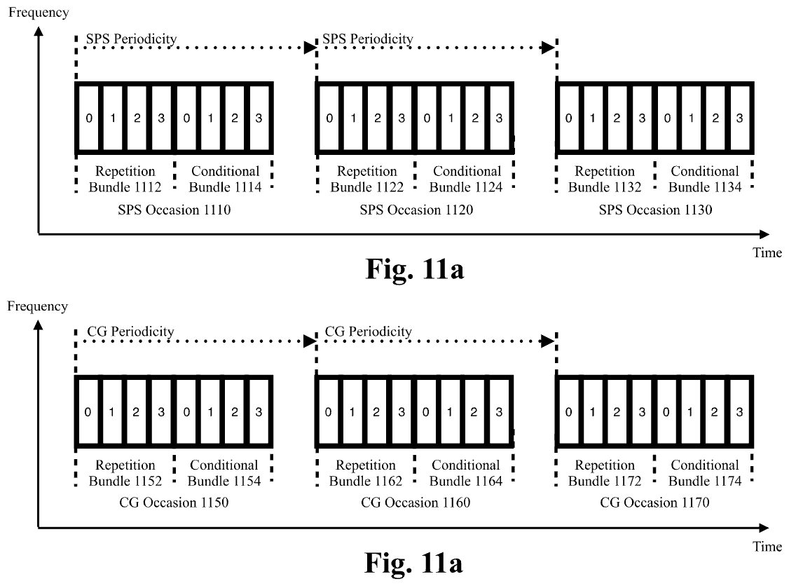

FIG. 11a shows an example of a single SPS occasion comprising a repetition bundle and a conditional bundle according to various exemplary embodiments. In this example, a first SPS occasion 1110 includes a repetition bundle 1112 and a conditional bundle 1114. Here, it may be considered that the number of transport block repetitions (K) is set to four. Thus, the repetition bundle 1112 includes resources indexed 0-3 and the conditional bundle 1114 also includes resources indexed 0-3. The HARQ process ID may be the same for each resource across the repetition bundle 1112 and the conditional bundle 1114.

In this example, SPS occasions are configured to occur at a configured SPS periodicity. The second SPS occasion 1120 includes a repetition bundle 1122 and a conditional bundle 1124. Thus, the repetition bundle 1122 includes resources indexed 0-3 and the conditional bundle 1124 also includes resources indexed 0-3. The HARQ process ID may be the same for each resource across the repetition bundle 1122 and the conditional bundle 1124. The third SPS occasion 1130 includes a repetition bundle 1132 and a conditional bundle 1134. Thus, the repetition bundle 1132 includes resources indexed 0-3 and the conditional bundle 1134 also includes resources indexed 0-3. The HARQ process ID may be the same for each resource across the repetition bundle 1132 and the conditional bundle 1134.

During operation, at least one resource of a conditional bundle may be activated if the repetition bundle in the same SPS occasion does not fulfill the configured number of transport block repetition (K). In another example, at least one resource of a conditional bundle within an SPS occasion may be activated at the UE 110 based on an explicit signal from the network.

FIG. 11b shows an example of a single CG occasion comprising a repetition bundle and a conditional bundle according to various exemplary embodiments. In this example, a first CG occasion 1150 includes a repetition bundle 1152 and a conditional bundle 1154. Here, it may be considered that the number of transport block repetitions (K) is set to four. Thus, the repetition bundle 1152 includes resources indexed 0-3 and the conditional bundle 1154 also includes resources indexed 0-3. The HARQ process ID may be the same for each resource across the repetition bundle 1152 and the conditional bundle 1154.

In this example, CG occasions are configured to occur at a CG periodicity. The second SPS occasion 1160 includes a repetition bundle 1162 and a conditional bundle 1164. Thus, the repetition bundle 1162 includes resources indexed 0-3 and the conditional bundle 1164 also includes resources indexed 0-3. The HARQ process ID may be the same for each resource across the repetition bundle 1162 and the conditional bundle 1164. The third CG occasion 1170 includes a repetition bundle 1172 and a conditional bundle 1174. Thus, the repetition bundle 1172 includes resources indexed 0-3 and the conditional bundle 1174 also includes resources indexed 0-3. The HARQ process ID may be the same for each resource across the repetition bundle 1172 and the conditional bundle 1174.

During operation, at least one resource of a conditional bundle may be activated if the repetition bundle in the same CG occasion does not fulfill the configured number of transport block repetition (K). In another example, at least one resource of a conditional bundle within an CG occasion may be activated at the UE 110 based on an explicit signal from the network.

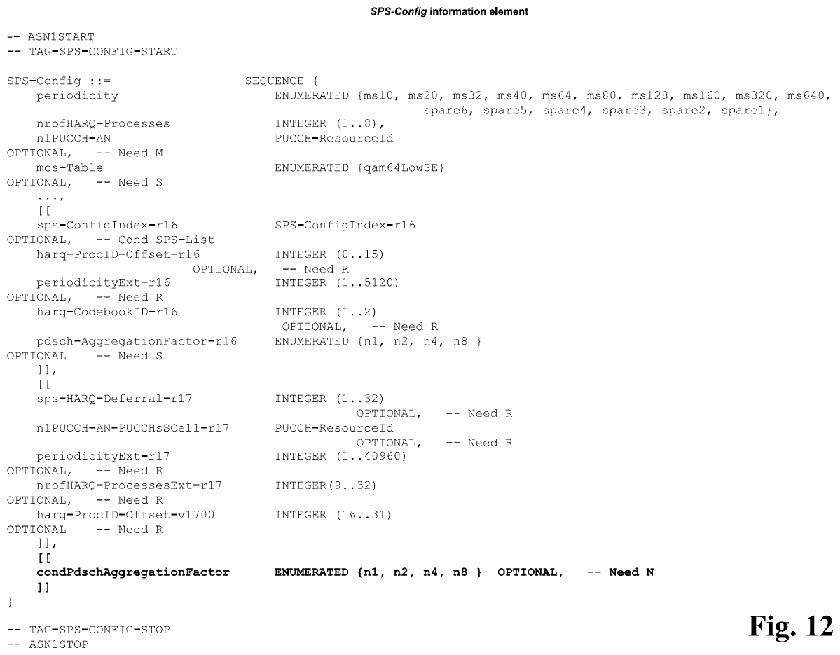

According to some aspects, the exemplary embodiments introduce an information element (IE) that may be provided in an SPS configuration IE (SPS-Config). This new IE may be referred to as condPdschAggregationFactor and indicate a number of repetitions for conditional bundles that are to follow a default PDSCH resource of each SPS occasion (e.g., repetition bundle). An example abstract syntax notation one (ASN.1) of an SPS-Config IE that includes the condPdschAggregationFactor IE introduced herein is shown in FIG. 12.

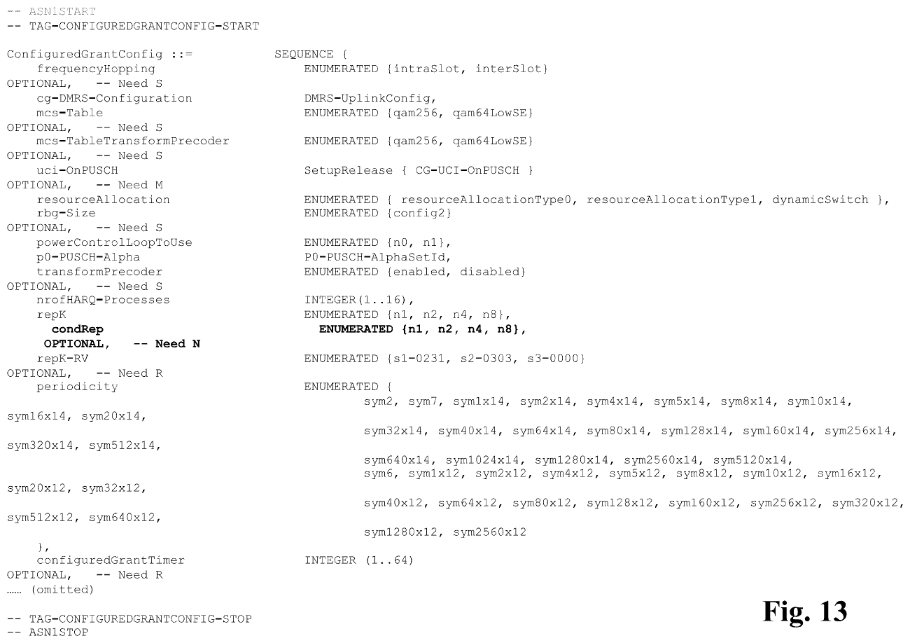

According to some aspects, the exemplary embodiments introduce an IE that may be provided in a CG configuration IE (ConfiguredGrantConfig). This new IE may be referred to as condRep and indicate a repetition number for conditional bundles that are to follow a default PUSCH resource of each CG occasion (e.g., repetition bundle). An example ASN.1 of an ConfiguredGrantConfig IE that includes the condRep IE introduced herein is shown in FIG. 13.

As mentioned above, the exemplary embodiments also introduce explicit signaling that may be used to activate conditional resources associated with a repetition bundle. In some embodiments, downlink control information (DCI) may be used to activate conditional resources. In one example, the DCI may be address to a configured scheduling (CS)-radio network temporary identifier (RNTI) of the UE 110. Those skilled in the art will understand that CS-RNTI a unique UE identification used for SPS in the downlink and type-2 CG in the uplink. Thus, this existing mechanism for SPS and type-2 CG activation may be used for activating conditional resources as configured scheduling resources. In another example, the DCI may be addressed to a new RNTI introduced herein for the purposes of activating conditional resources for transport block repetition.

In one embodiment, the exemplary DCI may be provided on a physical downlink control channel (PDCCH) after the first orthogonal frequency division multiplexing (OFDM) symbol of a repetition bundle. In another embodiments, the DCI may be sent on PDCCH before the first OFDM symbol of the repetition bundle. In this example, the UE 110 may skip the at least one resource of the repetition bundle upon the reception of the DCI on the PDCCH indicating one or more activated conditional resources. This may enable the UE 110 to save power instead of utilizing power to monitor empty PDSCH.

In another embodiment, the DCI includes a HARQ process ID and the UE 110 may determine if the conditional resource is activated for repetition. That is, if the HARQ process ID is indicated to be the same as a recent repetition bundle (e.g., within a predefined time interval) the UE 110 may assume that this conditional resource is activated to complete the required repetition.

The exemplary DCI described herein may include a purpose indicator field. The purpose indicator field indicate the purpose of the activation of the conditional resource which may be either for a new transmission (e.g., conventional SPS, CG activation) or for transport block repetition. The UE 110 may determine the HARQ process of the activated conditional resource based on the indicator and then the UE 110 may automatically set the HARQ process of the conditional resource as the HARQ process of the original repetition bundle. Otherwise, the HARQ process may be determined using any other appropriate mechanism. In some embodiments, the purpose indicator field may be a one bit flag where a first value indicates that the DCI is for conditional resource activation and a second different value indicates that the DCI is for conventional operations.

In addition, the exemplary DCI described herein may also include a set of resource to be activated field. If the purpose of the DCI is for conditional resource activation for transport block repetition, the DCI may further indicate a subset of the conditional resources to be activated. If this field is absent, the resources may be considered activated until a further deactivation command is received from the gNB 120A.

The exemplary embodiments also introduce conditional resource activation based on a MAC control element (CE). The network may also activate conditional resources associated with the repetition bundle via explicit signaling based on a MAC CE. The MAC CE may be conveyed in a MAC packet data unit (PDU) for either one of the PDSCH resources within the targeted repetition bundle or a PDSCH that is independent within the targeted repetition bundle.

In some embodiments, if the exemplary MAC CE is transmitted in one of the PDSCH resources within the targeted repetition bundle, the UE 110 may decode the repetition bundle. Assuming the MAC CE may be included in the repetition bundle, the PHY later should provide the transport block to the MAC layer to identify the presence of the MAC CE.

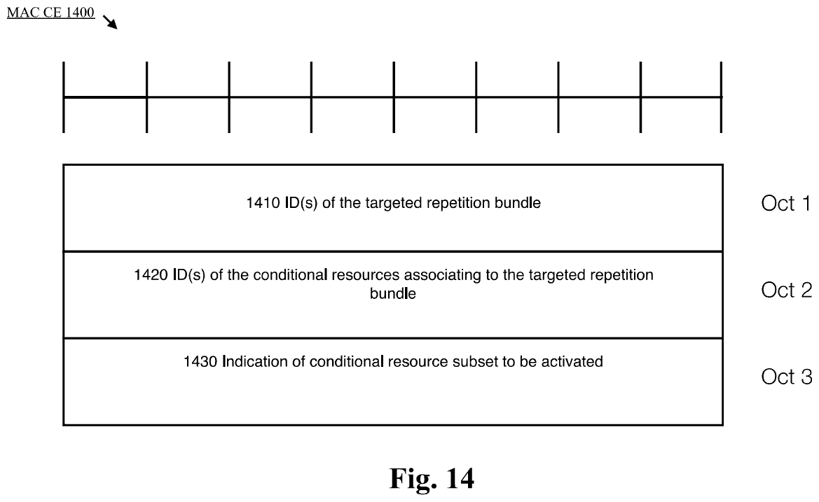

FIG. 14 shows an example of an exemplary MAC CE 1400 for conditional activation of resources for transport block repetition according to various exemplary embodiments. The exemplary MAC CE includes a first field 1410 configured to contain one or more IDs of a target repetition bundle. The ID may be an ID of an SPS or CG configuration. The exemplary MAC CE includes a second field 1420 configured to contain one or more IDs of the conditional resources associated with the targeted repetition bundle. The exemplary MAC CE 1400 may also include a third field 1430 configured to include an indication of conditional resources to be activated. For example, the set or subset of conditional resources associated to the targeted repetition bundle to be activated.

For uplink cases, when jitter occurs and the UE 110 cannot perform the configured number of repetitions within the repetition bundle, the UE 110 may send uplink control information (UCI) to the network. The UCI may be sent based on UCI multiplexing in a PUSCH resourced within the repetition bundle. Alternatively, the UCI may be sent on CG-UCI assuming the original repetition bundle is a CG or sent on an PUCCH.

In one example, the UCI may notify the gNB 120A that there is a jitter. In this example, upon reception of the UCI, the gNB 120A may further determine if the associated conditional resources should be activated for repetition. If so, explicit signaling (e.g., DCI, MAC CE, etc.) may be sent to the gNB 120A to activate the conditional resource.

In another example, the UCI may notify the gNB 120A that there is a jitter and recommend at least one part of the associated conditional resource should be activated. In this example, the UE 110 may recommend which of the preconfigured conditional resources may be activated. However, in some embodiments, the gNB 120A may have the final decision on whether the UE 110 is permitted to use the conditional resources for uplink transmissions.

In a further example, the UCI may notify the gNB 120A that at least one part of the associated conditional resources and which subset of the conditional resource will be activated. In this example, the UE 110 may autonomously activate the conditional resource without gNB 120A permission.

As described above, one of the repetitions may be performed on a conditional resource. For each resource within the set of conditional resources that are used to transmit a repetition, the UE 110 may determine its repetition index. In some embodiment, the repetition index may be determined based on mod(Total_Resource, Required_Repetition) where Total_Resource represents the number of activated resources within the conditional resource set plus the number of resources in the repetition bundle and Required_Repetition represents the number of require repetitions for the associated PUSCH. However, this example is merely provided for illustrative purposes. The exemplary embodiments may utilize any appropriate technique to determine the repetition index. In addition, a rule may be defined such that the HARQ process ID for the conditional resource is the same as the HARQ process ID derived using the first resource of the repetition bundle that activates the conditional resource.

According to some aspects, in the uplink, conditional resources may be CGs that are configured and already activated. In the following examples, the original repetition bundle may be denoted as CG #1 and the associate conditional resources may be denoted as CG #2. Initially, consider a scenario where a default CG #1 is associated with traffic flow #A and CG #2 is associated with traffic flow #B. In this scenario, CG #2 may be used for new transmission of data for traffic flow #B. However, when packets in traffic flow #A experiences jitter and insufficient repetition problems occur, CG #2 may be used for may be used to perform some or all of the transport block repetition for traffic flow #A. To provide an example, the transmission for data from traffic flow #B may be temporarily halted. The packets from traffic flow #A may use the resources of CG #2 if traffic flow #B does not have data available for transmission or the packets from traffic flow #A may use the resources of CG #2 if traffic flow #B has a lower priority than traffic flow #A. In this scenario, the HARQ process ID of CG #2 that is used by traffic flow #A may be derived by directly following the HARQ process ID of the associated CG #1.

### EXAMPLES

In a first example, a user equipment (UE) comprises a transceiver configured to communicate with a network and a processor communicatively coupled to the transceiver and configured to perform operations comprising receiving configuration information comprising allocation information for a downlink repetition bundle with a configured number of repetitions and conditional resources associated with the downlink repetition bundle, determining whether the conditional resources associated with the downlink repetition bundle are to be activated and decoding a transport block from physical downlink shared channel (PDSCH) received over multiple resources from at least one of the downlink repetition bundle and the conditional resources associated with the downlink repetition bundle.

In a second example, the UE of the first example, wherein a single semi-persistent scheduling (SPS) occasion comprises both the downlink repetition bundle and the conditional resources associated with the downlink repetition bundle.

In a third example, the UE of the second example, wherein a same hybrid automatic repeat request (HARQ) process ID is configured across all resources of both the downlink repetition bundle and the conditional resources associated with the downlink repetition bundle.

In a fourth example, the UE of the second example, the operations further comprising receiving an information element (IE) indicating a repetition number for the conditional resources associated with the downlink repetition bundle.

In a fifth example, the UE of the first example, the operations further comprising activating one or more conditional resources associated with the downlink repetition bundle and aggregating PDSCH from the downlink repetition bundle and the activated one or more conditional resources, wherein decoding the transport block is based on the aggregated PDSCH.

In a sixth example, the UE of the fifth example, wherein activating the one or more conditional resources associated with the downlink repetition bundle is based on determining that the downlink repetition bundle does not include data in one or more of the repetitions of the downlink repetition bundle.

In a seventh example, the UE of the fifth example, the operations further comprising receiving downlink control information (DCI), wherein activating the one or more conditional resources associated with the repetition bundle is based on the DCI.

In an eighth example, the UE of the seventh example, wherein the DCI includes a configured scheduling (CS)-radio network temporary identifier (RNTI).

In a ninth example, the UE of the seventh example, wherein the DCI includes a radio network temporary identifier (RNTI) specific to activating conditional resources for downlink transport block repetition.

In a tenth example, the UE of the seventh example, wherein the DCI is provided on physical downlink control channel (PDCCH) after a first orthogonal division multiplexing (OFDM) symbol of the repetition bundle.

In an eleventh example, the UE of the seventh example, wherein the DCI is provided on physical downlink control channel (PDCCH) before a first orthogonal division multiplexing (OFDM) symbol of the repetition bundle.

In a twelfth example, the UE of the seventh example, wherein the DCI includes a field indicating a hybrid automatic repeat request (HARQ) process ID of the downlink repetition bundle.

In a thirteenth example, the UE of the seventh example, wherein the DCI includes a field indicating a purpose of the activation of the one or more conditional resources.

In a fourteenth example, the UE of the seventh example, wherein the DCI includes a field identifying the one or more conditional resources to be activated.

In a fifteenth example, the UE of the fifth example, the operations further comprising receiving a medium access control (MAC) control element (CE), wherein activating the one or more conditional resources associated with the repetition bundle is based on the MAC CE.

In a sixteenth example, the UE of the fifteenth example, wherein the MAC CE is provided in one of the PDSCH resources within the downlink repetition bundle.

In a seventeenth example, the UE of the fifteenth example, wherein the MAC CE is provided in a PDSCH resource outside of the downlink repetition bundle.

In an eighteenth example, a method to perform any of the operations of the first through seventeenth examples.

In a nineteenth example, a base station comprises a transceiver configured to communicate with a user equipment (UE) and a processor communicatively coupled to the transceiver and configured to perform operations comprising transmitting configuration information to the UE comprising allocation information for a downlink repetition bundle with a configured number of repetitions and conditional resources associated with the downlink repetition bundle, determining whether the conditional resources associated with the downlink repetition bundle are to be activated and transmitting physical downlink shared channel (PDSCH) to the UE over multiple resources from at least one of the downlink repetition bundle and the conditional resources associated with the downlink repetition bundle, the PDSCH comprising a transport block repetition.

In a twentieth example, the base station of the nineteenth example, wherein a single SPS occasion comprises both the downlink repetition bundle and the conditional resources associated with the downlink repetition bundle.

In a twenty first example, the base station of the twentieth example, wherein a same hybrid automatic repeat request (HARQ) process ID is configured across all resources of both the downlink repetition bundle and the conditional resources associated with the downlink repetition bundle.

In a twenty second example, the base station of the twentieth example, the operations further comprising transmitting an information element (IE) to the UE, the IE indicating a repetition number for the conditional resources associated with the downlink repetition bundle.

In a twenty third example, the base station of the nineteenth example, the operations further comprising activating one or more conditional resources associated with the downlink repetition bundle and transmitting PDSCH over the downlink repetition bundle and the activated one or more conditional resources.

In a twenty fourth example, the base station of the twenty third example, wherein activating the one or more conditional resources associated with the downlink repetition bundle is based on determining a buffer is empty.

In a twenty fifth example, the base station of the twenty fourth example, wherein the buffer is one of a logical channel (LCH) buffer, a radio link control (RLC) buffer or a HARQ buffer.

In a twenty sixth example, the base station of the twenty third example, the operations further comprising transmitting downlink control information (DCI) to the UE, wherein the UE activates the one or more conditional resources associated with the repetition bundle based on the DCI.

In a twenty seventh example, the base station of the twenty sixth example, wherein the DCI includes a configured scheduling (CS)-radio network temporary identifier (RNTI).

In a twenty eighth example, the base station of the twenty sixth example, wherein the DCI includes a radio network temporary identifier (RNTI) specific to activating conditional resources for downlink transport block repetition.

In a twenty ninth example, the base station of the twenty sixth example, wherein the DCI is transmitted on physical downlink control channel (PDCCH) after a first orthogonal division multiplexing (OFDM) symbol of the repetition bundle.

In a thirtieth example, the base station of the twenty sixth example, wherein the DCI is transmitted on physical downlink control channel (PDCCH) before a first orthogonal division multiplexing (OFDM) symbol of the repetition bundle.

In a thirty first example, the base station of the twenty sixth example, wherein the DCI includes a field indicating a hybrid automatic repeat request (HARQ) process ID of the downlink repetition bundle.

In a thirty second example, the base station of the twenty sixth example, wherein the DCI includes a field indicating a purpose of the activation of the one or more conditional resources.

In a thirty third example, the base station of the twenty sixth example, wherein the DCI includes a field identifying the one or more conditional resources to be activated.

In a thirty fourth example, the base station of the twenty third example, the operations further comprising transmitting a medium access control (MAC) control element (CE) to the UE, wherein the UE activates the one or more conditional resources associated with the repetition bundle based on the MAC CE.

In a thirty fifth example, the base station of the thirty fourth example, wherein the MAC CE is transmitted on one of the PDSCH resources within the downlink repetition bundle.

In a thirty sixth example, the base station of the thirty fourth example, wherein the MAC CE is transmitted on a PDSCH resource outside of the downlink repetition bundle.

In a thirty seventh example, a method to perform any of the operations of the nineteenth through thirty sixth examples.

In a thirty eighth example, a processor of a user equipment (UE) configured to perform operations, the operations comprising receiving configuration information comprising allocation information for an uplink repetition bundle with a configured number of repetitions and conditional resources associated with the uplink repetition bundle, determining whether the conditional resources associated with the downlink repetition bundle are to be activated and transmitting physical uplink shared channel (PUSCH) to a base station over multiple resources from at least one of the uplink repetition bundle and the conditional resources associated with the uplink repetition bundle, the PUSCH comprising a transport block repetition.

In a thirty ninth example, the processor of the thirty eighth example, wherein a single configured grant (CG) occasion comprises both the uplink repetition bundle and the conditional resources associated with the uplink repetition bundle.

In a fortieth example, the processor of the thirty ninth example, wherein a same hybrid automatic repeat request (HARQ) process ID is configured across all resources of both the uplink repetition bundle and the conditional resources associated with the uplink repetition bundle.

In a forty first example, the processor of the thirty ninth example, the operations further comprising receiving an information element (IE) indicating a repetition number for the conditional resources associated with the uplink repetition bundle.

In a forty second example, the processor of the thirty eighth example, the operations further comprising activating one or more conditional resources associated with the uplink repetition bundle and transmitting PUSCH over the uplink repetition bundle and the activated one or more conditional resources.

In a forty third example, the processor of the forty second example, wherein activating the one or more conditional resources associated with the uplink repetition bundle is based on determining a buffer is empty.

In a forty fourth example, the processor of the forty second example, wherein the buffer is one of a logical channel (LCH) buffer, a radio link control (RLC) buffer or a HARQ buffer.

In a forty fifth example, the processor of the thirty eighth example, the operations further comprising transmitting uplink control information (UCI), wherein the UCI indicates to the base station that there is jitter associated with transport block repetition.

In a forty sixth example, the processor of the forty fifth example, the operations further comprising receiving a signal from the base station in response to the UCI, wherein the signal is configured to activate one or more of the conditional resources.

In a forty seventh example, the processor of the forty fifth example, wherein the UCI further recommends to the base station that one or more of the conditional resources are to be activated.

In a forty eighth example, the processor of the forty fifth example, wherein the UCI multiplexed in a PUSCH resource within the uplink repetition bundle.

In a forty ninth example, the processor of the thirty eighth example, the operations further comprising transmitting uplink control information (UCI), the UCI indicating that the UE has activated one or more of the conditional resources for transport block repetition.

In a fiftieth example, the processor of the forty ninth example, wherein the UCI multiplexed in a PUSCH resource within the uplink repetition bundle.

In a fifty first example, the processor of the thirty eighth example, wherein the uplink repetition bundle is a first configured grant (CG) occasion and the conditional resources is a second CG occasion.

In a fifty second example, the processor of the fifty first example, wherein the first CG occasion and the second CG occasion are associated with different traffic flows.

In a fifty third example, a user equipment comprises a transceiver configured to communicate with a network and a processor of any of the thirty eighth through fifty second examples.

In a fifty fourth example, a method to perform any of the operations of the thirty eighth through fifty second examples.

In a fifty fifth example, a processor of a base station configured to perform operations, the operations comprising transmitting configuration information to a user equipment (UE) comprising allocation information for an uplink repetition bundle with a configured number of repetitions and conditional resources associated with the uplink repetition bundle, determining whether the conditional resources associated with the downlink repetition bundle are to be activated and receiving physical uplink shared channel (PUSCH) from the UE over multiple resources from at least one of the uplink repetition bundle and the conditional resources associated with the uplink repetition bundle, the PUSCH comprising a transport block repetition.

In a fifty sixth example, the processor of the fifty fifth example, wherein a single configured grant (CG) occasion comprises both the uplink repetition bundle and the conditional resources associated with the uplink repetition bundle.

In a fifty seventh example, the processor of the fifty sixth example, wherein a same hybrid automatic repeat request (HARQ) process ID is configured across all resources of both the uplink repetition bundle and the conditional resources associated with the uplink repetition bundle.

In a fifty eighth example, the processor of the fifty sixth example, the operations further comprising transmitting an information element (IE) to the UE, the IE indicating a repetition number for the conditional resources associated with the uplink repetition bundle.

In a fifty ninth example, the processor of the fifty fifth example, the operations further comprising activating one or more conditional resources associated with the uplink repetition bundle and aggregating PUSCH from the uplink repetition bundle and the activated one or more conditional resources, wherein decoding the transport block is based on the aggregated PUSCH.

In a sixtieth example, the processor of the fifty ninth example, wherein activating the one or more conditional resources associated with the downlink repetition bundle is based on determining that the downlink repetition bundle does not include data in one or more of the repetitions of the downlink repetition bundle.

In a sixty first example, the processor of the fifty fifth example, the operations further comprising receiving uplink control information (UCI) from the UE, wherein the UCI indicates that there is jitter at the UE associated with uplink transport block repetition.

In a sixty second example, the processor of the sixty first example, the operations further comprising transmitting a signal to the UE in response to the UCI, wherein the signal is configured to activate one or more of the conditional resources.

In a sixty third example, the processor of the sixty first example, wherein the UCI further recommends that one or more of the conditional resources are to be activated.

In a sixty fourth example, the processor of the sixty first example, wherein the UCI multiplexed in a PUSCH resource within the uplink repetition bundle.

In a sixty fifth example, the processor of the fifty fifth example, the operations further comprising receiving uplink control information (UCI), the UCI indicating that the UE has activated one or more of the conditional resources for transport block repetition.

In a sixty sixth example, the processor of the sixty fifth example, wherein the UCI is multiplexed in a PUSCH resource within the uplink repetition bundle.

In a sixty seventh example, a base station comprises a transceiver configured to communicate with a user equipment (UE) network and a processor of any of the fifty fifth through sixty sixth examples.

In a fifty fourth example, a method to perform any of the operations of the fifty fifth through sixty sixth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving configuration information comprising allocation information for a downlink repetition bundle with a configured number of repetitions and conditional resources associated with the downlink repetition bundle;
determining whether the conditional resources associated with the downlink repetition bundle are to be activated; and
decoding a transport block from physical downlink shared channel (PDSCH) received over multiple resources from at least one of the downlink repetition bundle and the conditional resources associated with the downlink repetition bundle.

2. The processor of claim 1, wherein a single semi-persistent scheduling (SPS) occasion comprises both the downlink repetition bundle and the conditional resources associated with the downlink repetition bundle.

3. The processor of claim 2, wherein a same hybrid automatic repeat request (HARQ) process ID is configured across all resources of both the downlink repetition bundle and the conditional resources associated with the downlink repetition bundle.

4. The processor of claim 2, the operations further comprising:
receiving an information element (IE) indicating a repetition number for the conditional resources associated with the downlink repetition bundle.

5. The processor of claim 1, the operations further comprising:
activating one or more conditional resources associated with the downlink repetition bundle; and
aggregating PDSCH from the downlink repetition bundle and the activated one or more conditional resources, wherein decoding the transport block is based on the aggregated PDSCH.

6. The processor of claim 5, wherein activating the one or more conditional resources associated with the downlink repetition bundle is based on determining that the downlink repetition bundle does not include data in one or more of the repetitions of the downlink repetition bundle.

7. The processor of claim 5, the operations further comprising:
receiving downlink control information (DCI), wherein activating the one or more conditional resources associated with the repetition bundle is based on the DCI.

8. The processor of claim 7, wherein the DCI includes a configured scheduling (CS)-radio network temporary identifier (RNTI).

9. The processor of claim 7, wherein the DCI includes a radio network temporary identifier (RNTI) specific to activating conditional resources for downlink transport block repetition.

10. The processor of claim 7, wherein the DCI is provided on physical downlink control channel (PDCCH) after a first orthogonal division multiplexing (OFDM) symbol of the repetition bundle.

11. The processor of claim 7, wherein the DCI is provided on physical downlink control channel (PDCCH) before a first orthogonal division multiplexing (OFDM) symbol of the repetition bundle.

12. The processor of claim 7, wherein the DCI includes a field indicating a hybrid automatic repeat request (HARQ) process ID of the downlink repetition bundle.

13. The processor of claim 7, wherein the DCI includes a field indicating a purpose of the activation of the one or more conditional resources.

14. The processor of claim 7, wherein the DCI includes a field identifying the one or more conditional resources to be activated.

15. The processor of claim 5, the operations further comprising:
receiving a medium access control (MAC) control element (CE), wherein activating the one or more conditional resources associated with the repetition bundle is based on the MAC CE.

16. The processor of claim 15, wherein the MAC CE is provided in one of the PDSCH resources within the downlink repetition bundle.

17. The processor of claim 15, wherein the MAC CE is provided in a PDSCH resource outside of the downlink repetition bundle.

18. A processor of a base station configured to perform operations, the operations comprising:
transmitting configuration information to a user equipment (UE) comprising allocation information for a downlink repetition bundle with a configured number of repetitions and conditional resources associated with the downlink repetition bundle;
determining whether the conditional resources associated with the downlink repetition bundle are to be activated; and
transmitting physical downlink shared channel (PDSCH) to the UE over multiple resources from at least one of the downlink repetition bundle and the conditional resources associated with the downlink repetition bundle, the PDSCH comprising a transport block repetition.

19. The processor of claim 18, wherein a single SPS occasion comprises both the downlink repetition bundle and the conditional resources associated with the downlink repetition bundle.

20. The processor of claim 19, wherein a same hybrid automatic repeat request (HARQ) process ID is configured across all resources of both the downlink repetition bundle and the conditional resources associated with the downlink repetition bundle.

21-24. (canceled)
